(19) United States
(12) Patent Application Publication
(10) Pub. No.: US 2019/0234138 A1
(43) Pub. Date: Aug. 1, 2019

(54) PET DOOR

(71) Applicant: Larson Manufacturing Company of South Dakota, Inc., Brookings, SD (US)

(72) Inventor: Bryan P. Zacher, Brookings, SD (US)

(21) Appl. No.: 16/257,976

(22) Filed: Jan. 25, 2019

Related U.S. Application Data
(60) Provisional application No. 62/622,260, filed on Jan. 26, 2018.

(51) Int. Cl. E06B 7/32

(52) U.S. Cl. CPC E06B 7/32

(57) ABSTRACT

A door assembly including a door structure, at least a first panel mounted within the door structure, wherein the first panel includes a pet door opening, and a pet door assembly mounted to the first panel. The pet door assembly includes an exterior frame positioned on a first side of the first panel adjacent the pet door opening, an interior frame positioned on a second side of the first panel adjacent the pet door opening, and a pet door flap mounted to one of or between the interior frame and exterior frame and positioned within the pet door opening.

### CROSS-REFERENCE TO RELATED APPLICATIONS

This application claims priority to U.S. Provisional Patent Application No. 62/622,260, filed Jan. 26, 2018, the entire contents of which are incorporated herein by reference in its entirety.

### TECHNICAL FIELD

The present invention relates to a pet door, and more particularly relates to a pet door positioned within an opening in a solid door panel, such as a glass panel of an access door.

### BACKGROUND

Pet doors have been commercially available for a number of years for the convenience of homeowners who wish to allow their pets to freely move between outside and inside the home. The pet doors are typically provided as a pet-specific sized opening or portal in an otherwise solid door surface, and often include a panel or flap that must be moved by the pet in order to access the opening. The panel or flap is provided to protect the inner side of the door from wind, rain, or even intruders.

There is a continued desire to provide different styles of pet doors for a wide variety of applications that provide relatively easy access by a pet, yet provide protection from the outdoor elements and security for the homeowner.

### SUMMARY

In accordance with embodiments provided herein, a door assembly is provided that includes a door structure, a first panel mounted within the door structure, a second panel mounted within the door structure that includes a pet door opening, wherein the first panel is vertically repositionable relative to the second panel, and a pet door assembly mounted to the second panel. The pet door assembly includes an exterior frame positioned on a first side of the second panel, an interior frame positioned on a second side of the second panel, and a pet door flap mounted to one of the interior frame and exterior frame and/or between the interior frame and exterior frame, and positioned within the pet door opening. The exterior frame is attached to the interior frame through the pet door opening.

In accordance with embodiments, the pet door flap may include a lower edge and a pet door magnet extending along at least a portion of the lower edge. The pet door magnet may include a U-shaped member. A portion of at least one of the interior frame and the exterior frame may include a frame magnet. At least one of the interior frame, the exterior frame, and the pet door flap may include a magnetized surface, and at least one surface that is not magnetized of the interior frame, the exterior frame, and the pet door flap may include a ferromagnetic material, which may be steel. At least a portion of the pet door flap may be flexible and/or rigid. The first panel may be repositionable to expose a screen portion within the door structure. The pet door assembly may include at least one gasket, and the pet door flap may be vertically adjustable. The pet door assembly may further include a removable pet door cover adjacent the interior frame of the pet door assembly. The exterior frame of the pet door assembly may include at least one connector member for accepting a fastener, wherein the fastener may be a threaded screw. The connector member(s) may not be accessible from an outer surface of the exterior frame.

In accordance with another embodiment, a door assembly is provided that includes a door structure, a panel mounted within the door structure, wherein the panel includes a pet door opening, and a pet door assembly mounted to the panel. The pet door assembly includes an exterior frame positioned on a first side of the panel, an interior frame positioned on a second side of the panel, and a pet door flap mounted between the interior frame and exterior frame and positioned within the pet door opening, wherein the exterior frame is attached to the interior frame through the pet door opening.

### BRIEF DESCRIPTION OF THE DRAWINGS

The present invention will be further explained with reference to the appended Figures, wherein like structure is referred to by like numerals throughout the several views, and wherein;

FIG. 1 is a front view of an embodiment of a door assembly including a pet door;

FIG. 2 is a perspective view of the door assembly of FIG. 1;

FIG. 3 is a exploded perspective view of the pet door assembly portion of the door assembly of FIG. 1;

FIG. 4 is an enlarged perspective detail view taken from the encircled area indicated by reference number 4 of the door assembly of FIG. 3;

FIG. 5 is an enlarged perspective detail view taken from the encircled area indicated by reference number 5 of the door assembly of FIG. 3;

FIG. 6 is an enlarged cross-sectional side view taken along section line 6-6 of the door assembly of FIG. 1;

FIG. 7 is an enlarged cross-sectional side view taken along section line 7-7 of the door assembly of FIG. 1;

FIG. 8 is a perspective view of the door assembly of FIG. 1 in a configuration in which an upper glass panel has been moved partially toward the bottom of the door structure such that a screen is exposed in the area from which the glass panel was moved;

FIG. 9 is a perspective view of the door assembly of FIG. 1 in a configuration in which an upper glass panel has been moved its full distance downward to the bottom of the door structure such that it covers the pet door and so that a screen is exposed in the area from which the glass panel is moved;

FIG. 10 is a front view of an embodiment of a framed glass panel including a pet door, in accordance with the invention;

FIG. 11 is a perspective view of the glass panel including a pet door of FIG. 10;

FIG. 12 is a perspective view of an embodiment of a door assembly including a pet door;

FIG. 13 is a perspective view of an embodiment of a framed glass panel including a pet door;

FIG. 14 is a perspective view of the interior side of an embodiment of a door assembly, such as the door assembly of FIG. 1, that includes an optional pet door cover;

FIG. 15 is a perspective view of an embodiment of a glass panel with a partial door frame and including a pet door; and

FIG. 16 is a perspective view of a panel including a pet door.

### DETAILED DESCRIPTION

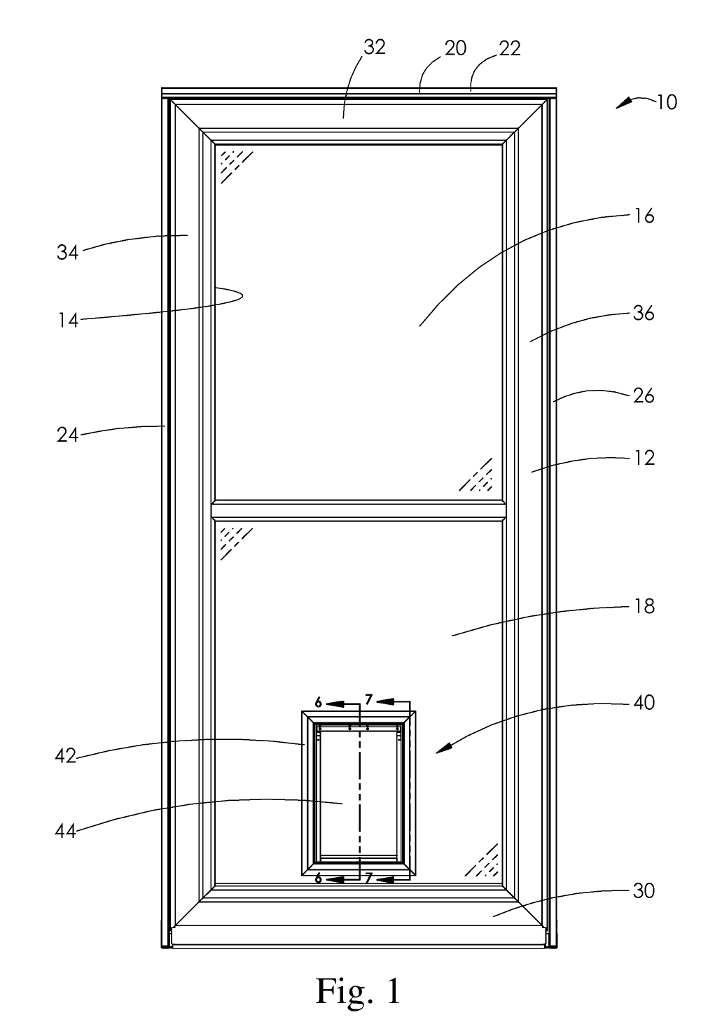

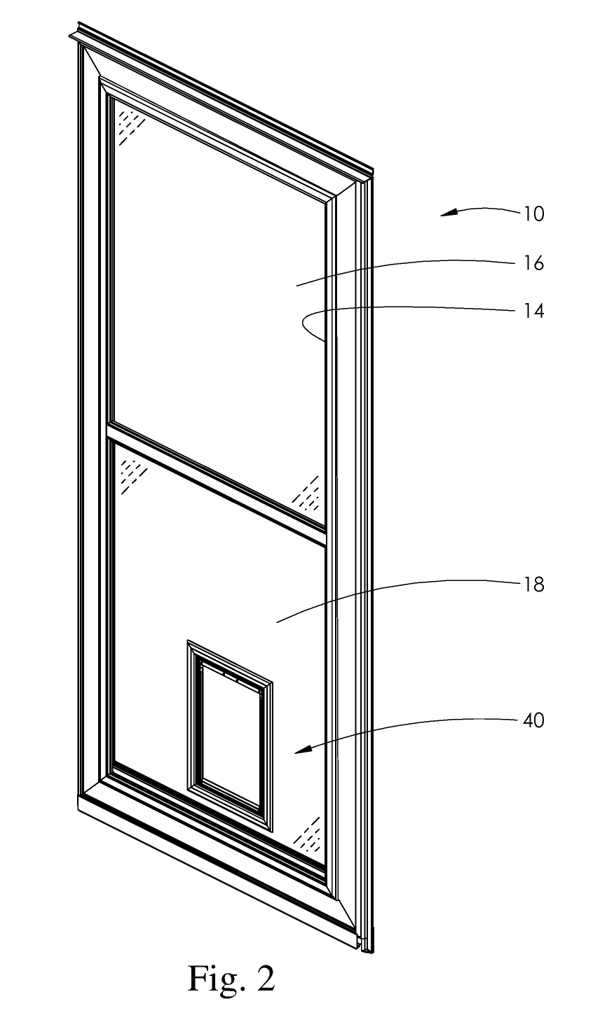

Referring now to the Figures, wherein the components are labeled with like numerals throughout the several Figures, and initially to FIGS. 1 and 2, one preferred configuration of a door assembly 10 is illustrated, which generally includes a door structure 12 with a central opening 14, and first and second panels 16, 18 mounted within the opening 14. The first and second panels 16, 18 can be transparent glass or another transparent, translucent, or opaque material. The first and second panels 16, 18 are positioned within outer frames (not visible). At least the first panel 16 is moveable relative to the second panel 18, such as by mounting the first panel 16 in a track that is separate from and offset from a track or other structure in which second panel 18 is mounted. In an embodiment, the second panel 18 is fixed or stationary while first panel 16 is moveable; however, it is contemplated that only the second panel 18 is moveable and/or that both panels 16, 18 are moveable relative to each other. When the panel 16 is in its completely upward or closed position, a locking mechanism (not shown) can be engaged to lock the panels relative to each other within the door structure 12.

Door structure 12 is operably mounted to a door frame 20, which can be mounted within a building structure, for example. Door frame 20 includes a top frame 22, left frame member 24, and right frame member 26. A hinge system (not shown) allows door structure 12 to pivot with respect to the door frame 20.

While the door assemblies used in accordance with the invention can have a wide variety of configurations, the illustrated embodiment of the door structure 12 includes a sill 30, a header 32 generally parallel to sill 30 when the door structure 12 is assembled, a left jamb 34 extending between sill 30 and header 32, and a right jamb 36 that is spaced from and generally parallel to the left jamb 34, and that extends between sill 30 and header 32. Each of these four structural members includes mitered ends cut at an angle of approximately 45 degrees. These four structural members can be connected to each other via four corner key members or L-shaped members, for example, each of which is located at one of the four corners and are provided to ensure that the miters align on the exterior surface of the door structure 12 and to increase the strength of each corner. Door structure 12 may further include one or more fasteners (e.g., screws) to connect the four corners when the frame is assembled. Any of the sill 30, the header 32, the left jamb 34, and the right jamb 36 may include screw bosses for receiving fasteners during assembly of the door structure 12. The sill 30, header 32, and left and right jambs 34, 36 can be made of extruded aluminum or another relatively rigid material, as is known in the industry, or may be integrated into a single rectangular member made from a relatively rigid structural panel (e.g., particleboard).

The door assembly 10 can be used as a storm door, which will typically be positioned outside the main door of a home to protect the main door and interior of the home from rain, snow, wind, and the like, but that can be reconfigured to allow fresh air to enter the home, such as by moving the panels of glass relative to each other, as will be explained below. The door frame 20 will be provided with mounting surfaces on frame members 22, 24, and/or 26 that allow for attachment to a door opening of a building, such as a house. The outer or exterior side of the door assembly 10 is illustrated in FIGS. 1 and 2 which is the side that one would typically view when approaching a home from the outside, although this visible side of the door assembly 10 can instead be positioned to be the inner or interior side (i.e., viewable from the inside of a home). The door assembly 10 may further include hardware such a handle, lock, and the like to assist the user in opening and closing the door.

Door assembly 10 further includes a pet door assembly 40 attached to or within the second panel 18 to allow for movement of a pet from one side of the door assembly 10 to the other. The pet door assembly generally includes a frame 42 within which a moveable flap 44 is positioned, as will be described below in further detail.

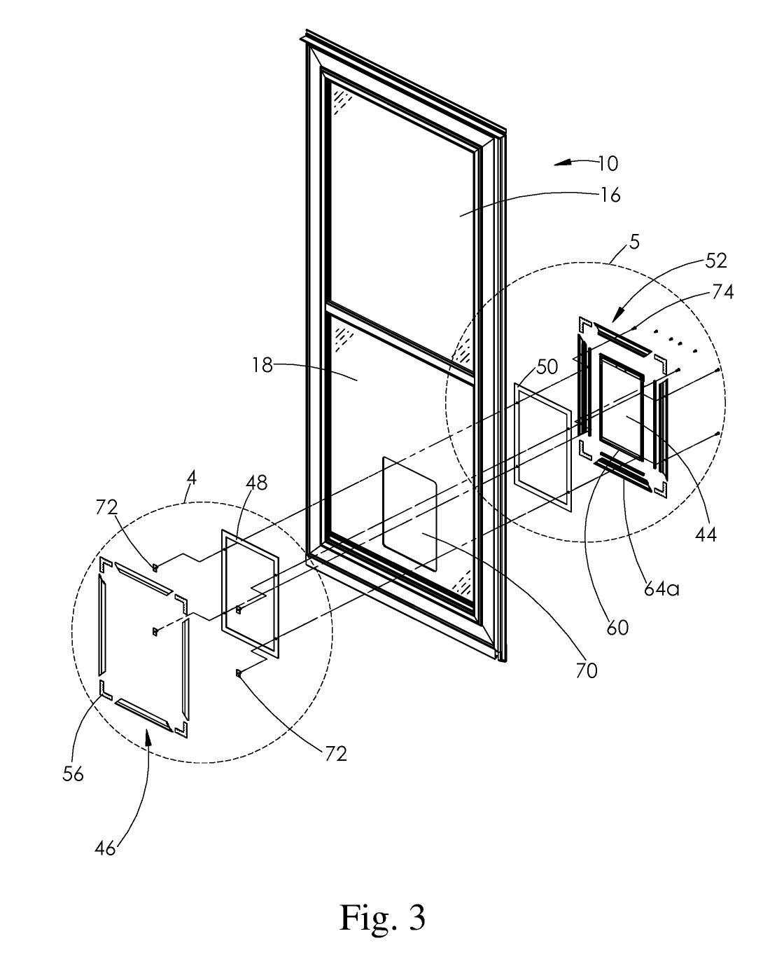

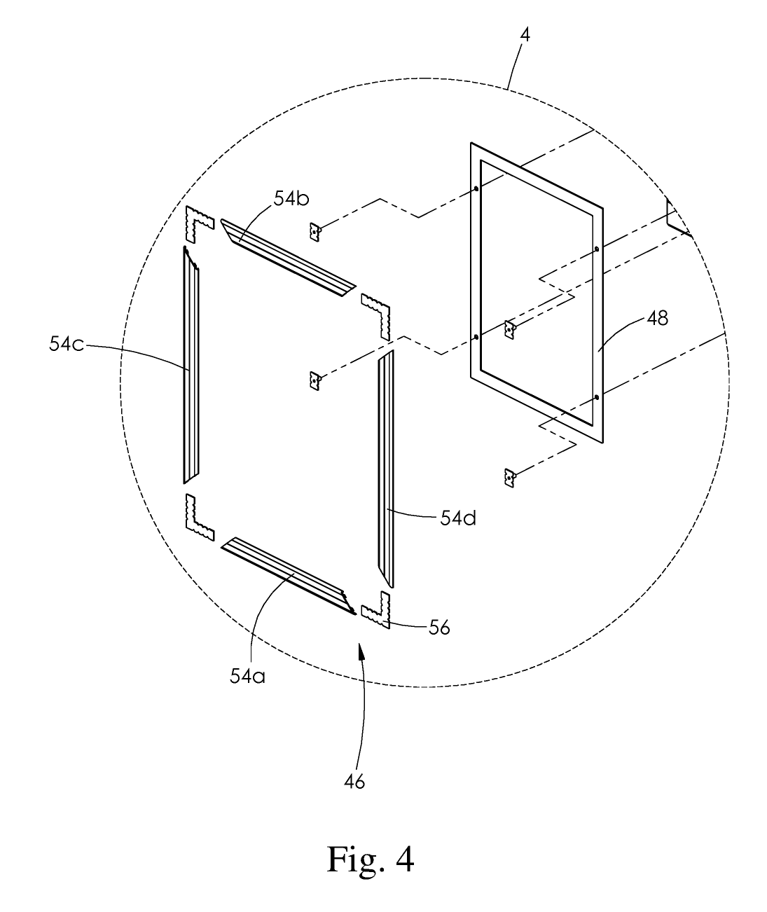

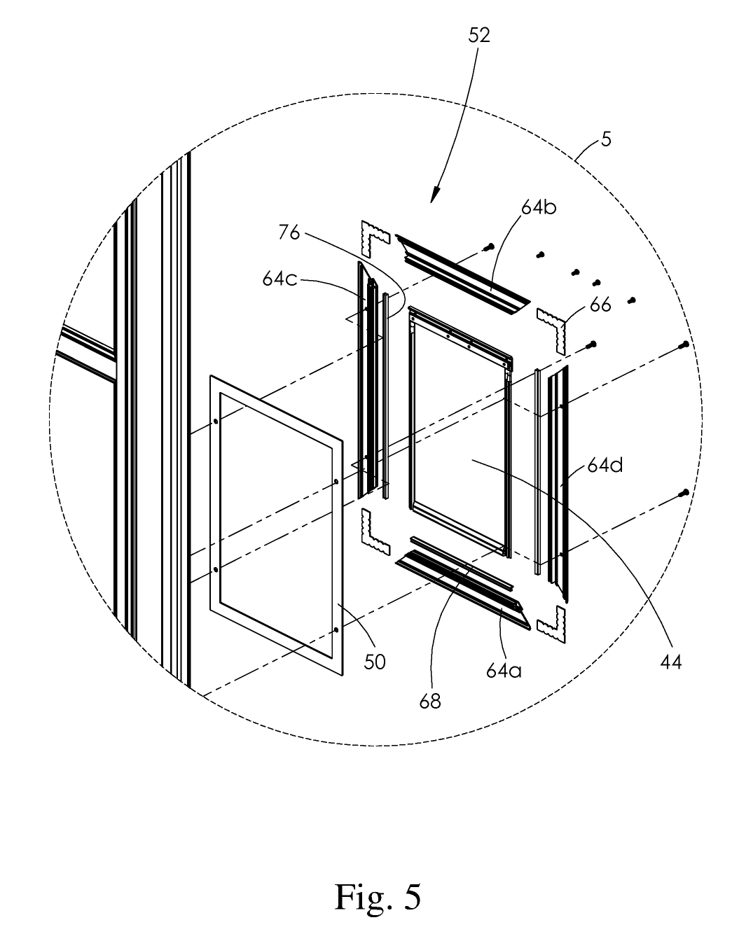

Referring now to FIG. 3, an exploded perspective view of the pet door assembly portion of the door assembly 10 is illustrated, along with FIGS. 4 and 5 that provide for further enlarged views of circled portions 4 and 5 of FIG. 3, respectively. Pet door assembly 40 generally includes the flap 44, an exterior frame 46, an exterior gasket 48, an interior gasket 50, and an interior frame 52.

As shown, the exterior frame 46 includes a sill or lower member 54a, a header or upper member 54b generally parallel to lower member 54a when the exterior frame 46 is assembled, a left member 54c extending between lower member 54a and upper member 54b, and a right member 54d spaced from and generally parallel to the left member 54c and that extends between lower member 54a and upper member 54b. These members 54a-54d can each be an extruded member made of aluminum, plastic, vinyl, or other material that may have a wide variety of cross-sectional shapes (e.g., rectangular) and/or can be either solid or hollow. Each of these four structural members 54a-54d includes mitered ends cut at an angle of approximately 45 degrees. These four structural members 54a-54d can be connected to each other via corner key members or L-shaped members 56, for example, each of which is located at one of the four corners and are provided to ensure that the miters align on the exterior surface of the exterior frame 46 and to increase the strength of each corner. Alternatively, structural members 54a-54d can be integrated into a single component and molded from a material such as polyvinylchloride, polyethylene, polypropylene, or the like, for example.

Exterior gasket 48 and interior gasket 50 may be made of the same or a different material as each other, and may be the same or a different thickness as each other. Gaskets 48, 50 may be made of a material such as foam, rubber, or other flexible material that can be at least partially compressed during assembly of the pet door assembly 40. In this way, the area surrounding the pet door assembly 40 will be sealed from leaks of water and air moving in either direction through the door and/or to prevent an irregularity on either side of the interior or exterior frames from contacting the glass directly, for example. In an alternative door assembly embodiment, one or both of the gaskets 48, 50 are not provided as part of the pet door assembly.

Interior frame 52 may be similarly constructed to the exterior frame 46, although the dimensions, materials, and/or other features may be different, such as to provide for different protection from the elements from the exterior side of the door, for example. In this illustrated embodiment, the interior frame 52 includes a sill or lower member 64a, a header or upper member 64b generally parallel to lower member 64a when the interior frame 52 is assembled, a left member 64c extending between lower member 64a and upper member 64b, and a right member 64d spaced from and generally parallel to the left member 64c, and that extends between lower member 64a and upper member 64b. These members 64a-64d can each be an extruded member made of aluminum, plastic, vinyl, or other material that may have a wide variety of shapes (e.g., rectangular) and/or can be either solid or hollow. Each of these four structural members includes mitered ends cut at an angle of approximately 45 degrees. These four structural members can be connected to each other via four corner key members or L-shaped members 66, for example, each of which is located at one of the four corners and are provided to ensure that the miters align on the exterior surface of the interior frame 52. Alternatively, structural members 64a-64d can be integrated into a single component and molded from a material such as polyvinylchloride, polyethylene, polypropylene, or the like, for example. Lower member 64a may optionally be magnetized or may include a magnet 68 extending along at least a portion of its length.

The flap 44 of pet door assembly 40 is a rectangular piece of material that can either be transparent, translucent, or opaque. The flap may be made of a relatively flexible material, an articulating assembly made of multiple pieces, a relative rigid material, or a combination of rigid and flexible materials. The top portion of the flap 44 is attachable along its edge at or near the upper member 64b, and can include adjustability features to allow for the desired positioning of the flap 44. In an embodiment, one or more additional connector members may be provided that include slotted holes or other features (not shown) that allow for vertical adjustment of the flap 44 within the opening formed by members 64a-64d. In an alternative embodiment, flap 44 may be attachable to upper member 54b of exterior frame 46.

The flap 44 further includes a magnet 60 along at least a portion of its bottom edge that will provide for magnetic attraction between magnet 60 and magnet 68 of lower member 64a and/or magnetic attraction between magnet 60 and a magnetized portion of lower member 64a. In order to provide relatively easy movement of the flap 44 by a pet moving through the door in either direction, the flap 44 will typically not “overlap” or extend below the top surface of the magnet 68 of lower member 64a and/or the magnetized portion of member 64a. However, the flap 44 should be vertically adjusted to provide for sufficient contact between its magnet 60 and the magnet 68 of lower member 64a and/or the magnetized portion of lower member 64a when the flap 44 is in its closed position. Lower member 64a may be provided with a magnet 68 that is movable with respect to lower member 64a, with clearance provided between magnets 60 and 68 to enable the flap 44 to move freely as the pet moves through the opening while allowing magnets 60 and 68 to move into contact each other when the flap 44 comes to rest in the vertical position.

While much of the discussion herein refers to attraction between a magnet on the pet door flap and at least one corresponding magnet on the pet door frame, it is understood that only one of these structures or surfaces may be magnetized while the other(s) are instead made of steel or another material for attracting the magnet and maintaining the pet door flap in its closed position. For example, the flap can include a magnet along at least a portion of its bottom edge while a corresponding portion of the pet door frame is steel or another ferromagnetic material, or the flap can include steel or another ferromagnetic material along at least a portion of its bottom edge while a corresponding portion of the pet door frame includes a magnet or is magnetized.

With particular reference again to FIG. 3, second panel 18 includes an opening 70 through which the interior and exterior portions of the pet door assembly 40 can be assembled to each other and secured to the second panel 18. To assemble the pet door assembly 40, at least one of the members 54a-54d of the exterior frame 46 includes at least one connector member 72 with an aperture or other feature for accepting a fastener 74, such as a threaded screw. In embodiments of the invention, the connection between the interior and exterior portions of the pet door assembly is configured so that the pet door cannot be disassembled from the exterior of door assembly 10. During assembly, the flap 44, exterior frame 46, exterior gasket 48, interior gasket 50, and interior frame 52 are moved toward each other and the opening 70 such that openings of the gaskets 48, 50 and the interior frame 52 are aligned with the connector members 72 extending from the left and right side members 54c, 54d. The fasteners 74 are then extended through these openings to attach to the connector members 72. In an embodiment, fastener 74 is a threaded screw and connector members 72 include threads for mating with the threaded screws. In an embodiment that includes structural members molded into a single component, one or more of the connection members may be integrated into the molded component(s).

As shown, the connection of these components to each other is through the opening 70 in second panel 18 and not through corresponding additional holes in the panel 18. However, in an alternative embodiment, one or more additional holes can be provided through the glass adjacent to the opening 70 for receiving a corresponding fastener. Once all of the components are assembled, the flap 44 may be adjusted to provide the desired positioning of the magnet 60 of the flap relative to the magnet 68 and/or the magnetized portion of lower member 64a. Optional weather stripping 76 may also be attached to one or both sides of the interior frame 52.

In an alternative embodiment, connector members 72 and fasteners 74 may be eliminated and gaskets 48 and 50 may be replaced with adhesive (e.g., a bead of structural adhesive) applied between the exterior frame 46 and panel 18 and between interior frame 52 and panel 18 to both secure the exterior and interior frames in alignment with each other and serve as a seal against water and air. In yet another embodiment, connector members 72 and fasteners 74 may be eliminated and gaskets 48 and 50 may be replaced with an adhesive tape (e.g., a two-sided and/or structural adhesive tape) applied between the exterior frame 46 and panel 18 and between interior frame 52 and panel 18 to both secure the exterior and interior frames in alignment with each and serve as a seal against water and air.

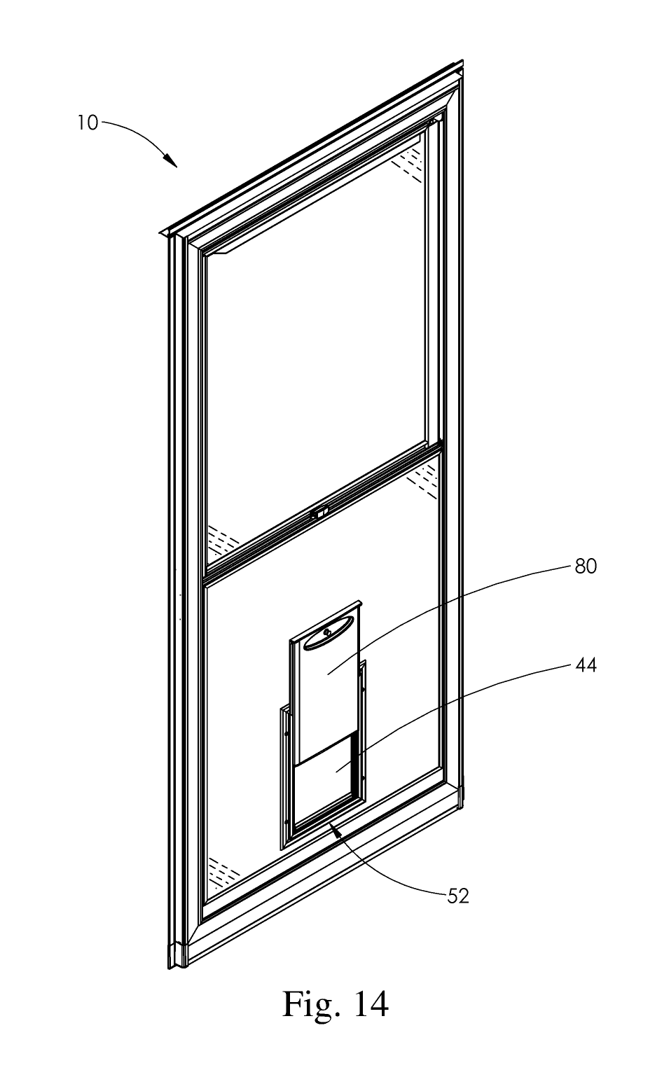

Referring now to FIG. 14, door assembly 10 may further include an adjustable and/or removable pet door cover 80 to cover and uncover the flap 44, such as when it is desired to block movement of a pet through the door, such as during vacations, during particularly inclement weather, or to prevent entry of rodents or other undesired intruders. Such a pet door cover will be installable on the interior side of the door, and can include a locking mechanism (not illustrated) to securely hold the cover in a desired location. One exemplary configuration includes two vertically-extending side rails positioned on either side of the interior frame into which a cover can slide to cover the opening in which the flap is installed.

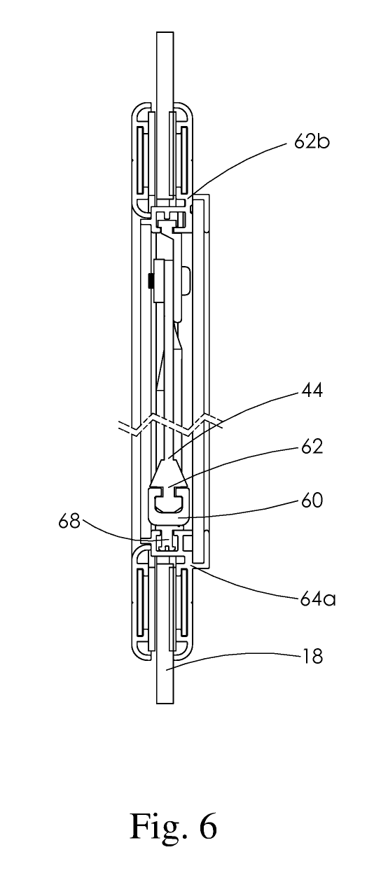

FIG. 6 is an enlarged cross-sectional side view taken along section line 6-6 of the door assembly of FIG. 1. As shown, flap 44 includes a bottom portion 62 to which a U-shaped magnet 60 is attached, which is positioned adjacent to magnet 68 when in the illustrated closed position.

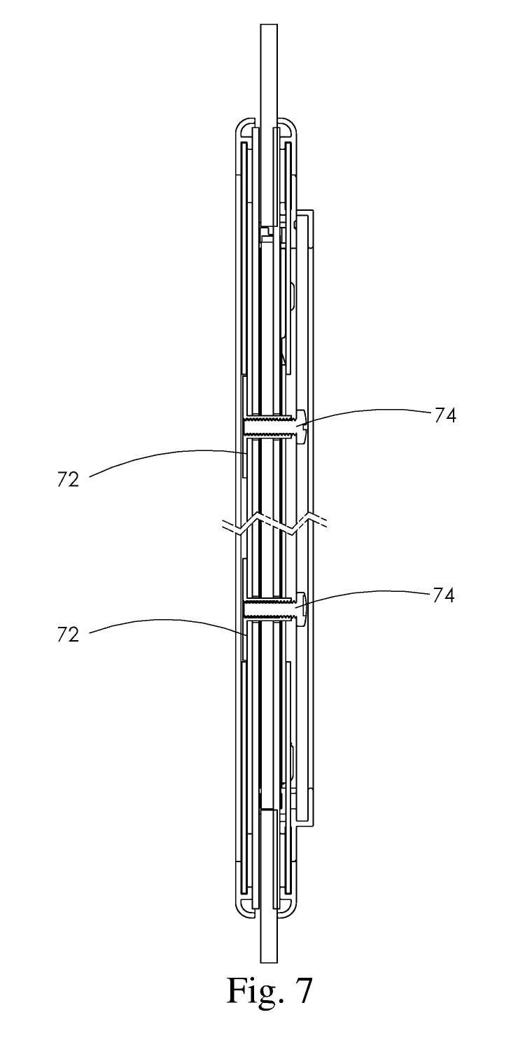

FIG. 7 is an enlarged cross-sectional side view taken along section line 7-7 of the door assembly of FIG. 1. Because this cross-section is taken through the right side of the pet door frame, the positioning of the several components relative to each other can be seen, along with two of the fasteners 74 positioned within connector members 72 for securing the components together as an assembly.

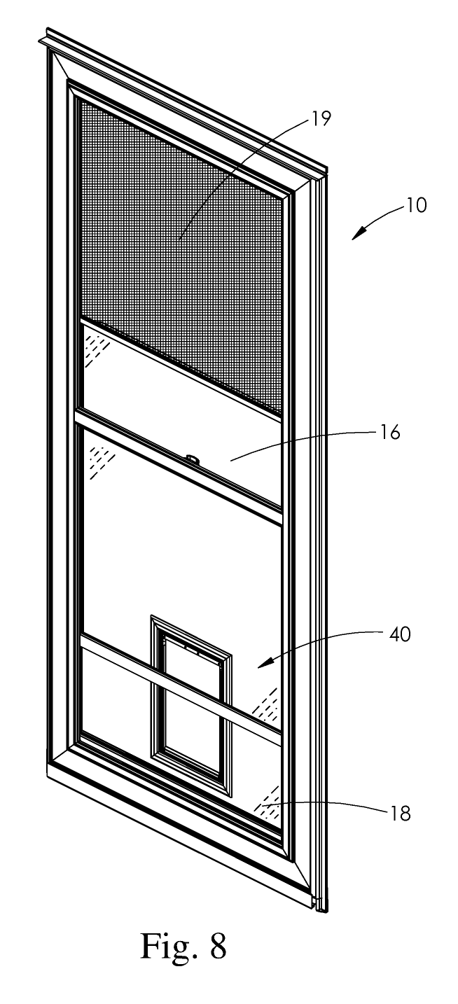

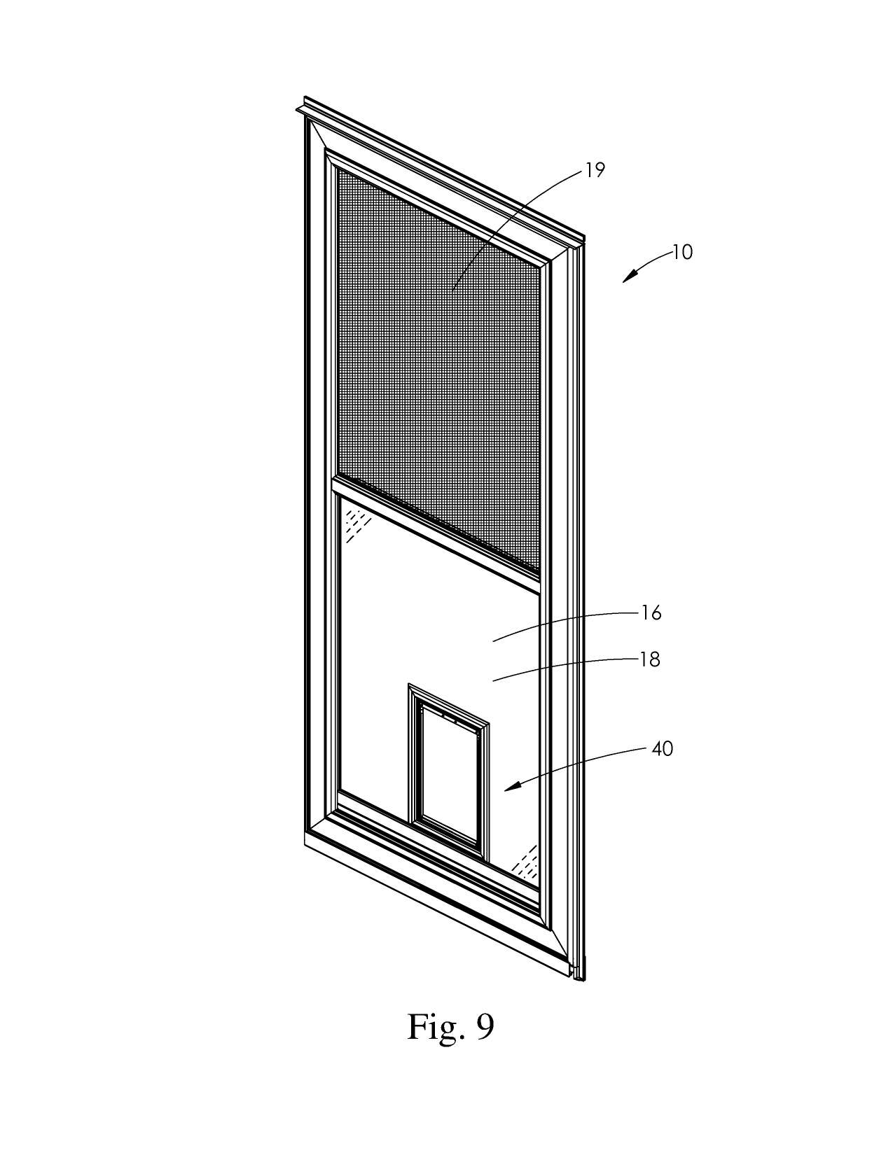

FIG. 8 is a perspective view of door assembly 10 with first panel 16 moved downwardly to partially cover second panel 18. Because door assembly 10 includes screen material 19 that is connected to the top area of the first panel 16, the screen material 19 is exposed in the area from which the first panel 16 has been vertically moved. The screen material 19 may be provided as a roll of material that is unrolled by an amount that is proportionate to the distance the first panel is moved downwardly so that the central area of the door assembly is always covered by one or more of the panels 16, 18 or the screen material 19. As shown, the bottom area of the first panel 16 is partially covering a pet door assembly 40 in FIG. 8, and FIG. 9 illustrates the configuration in which the first panel 16 is completely covering the pet door assembly 40 and the screen material 19 is covering the opening in the door structure from which the first panel 16 has been moved. The door assembly 10 may optionally be provided with a moveable or permanent stop feature (not shown) that prevents unintentional movement of the first panel 16 over the pet door assembly 40.

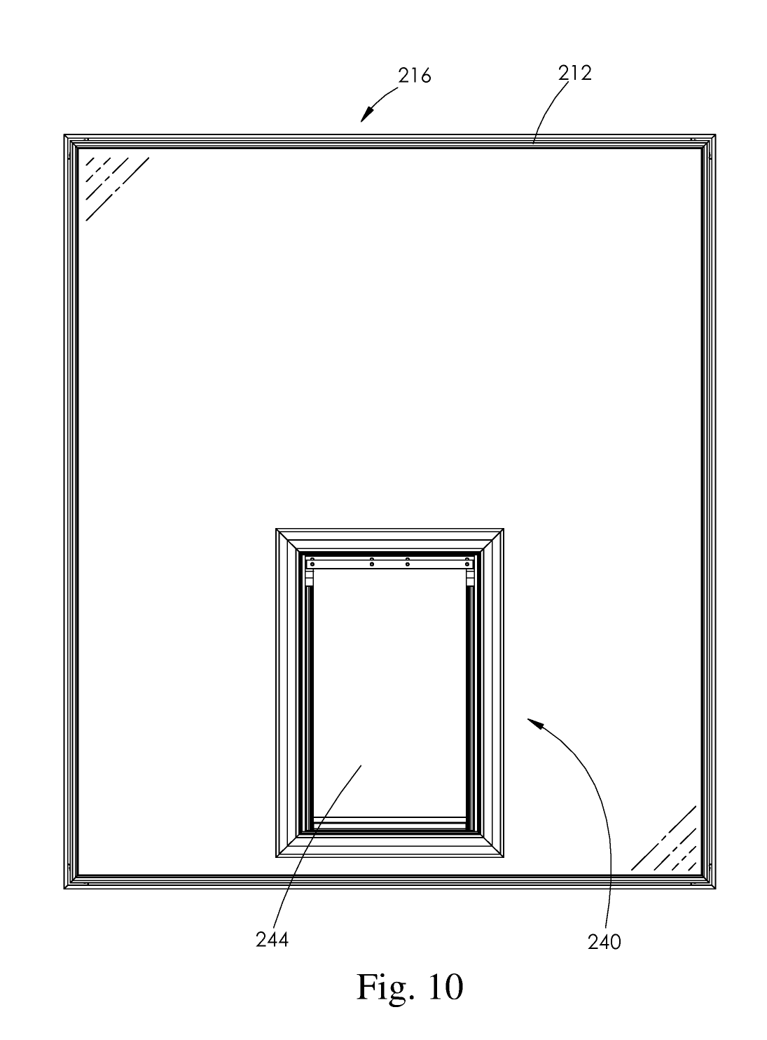

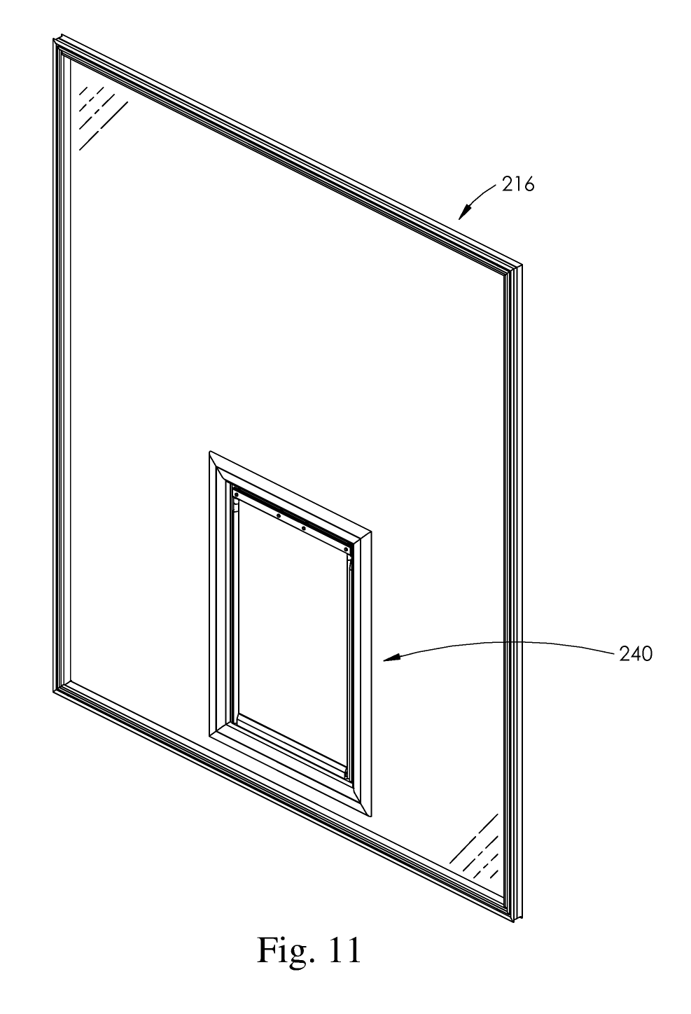

FIG. 10 is a front view of an embodiment of a single glass panel 216 having a frame 212 and including a pet door assembly 240 with a flap 244, in accordance with the invention. FIG. 11 is a perspective view of the glass panel 216 of FIG. 10. This glass panel 216 can be used to retrofit a door that was originally made without a pet door assembly, or to replace a broken pet door panel, for example.

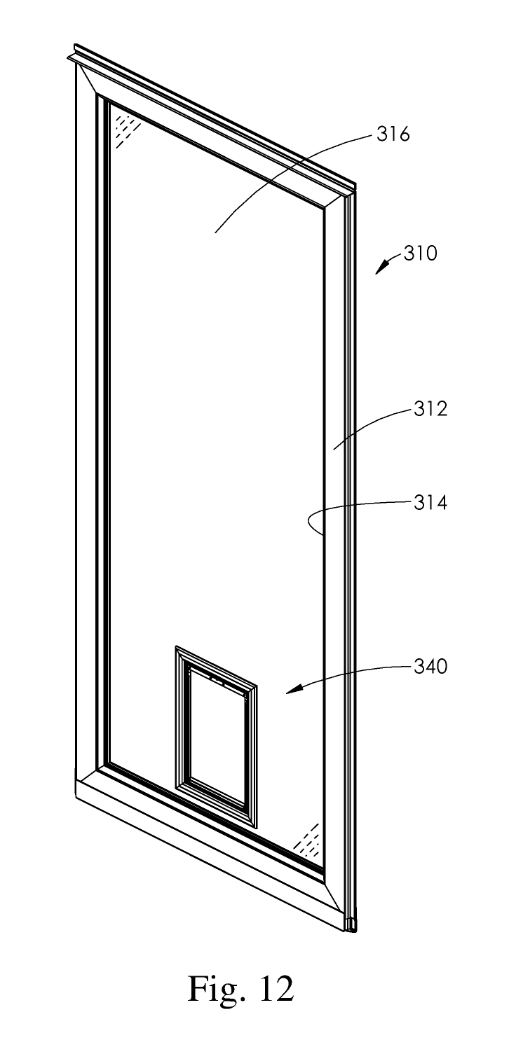

FIG. 12 illustrates a door assembly 310 which generally includes a door structure 312 with a central opening 314, and a panel 316 mounted within the opening 314. The panel 316 can be transparent glass or another transparent, translucent, or opaque material. In this embodiment, the door assembly 310 is illustrated as a “full-view” type of door, which generally provides the largest amount of viewing area possible for a user by maximizing the amount of open area for a door while maintaining the structural integrity of the door. Door assembly 310 further includes a pet door assembly 340 provided with features and configurations described above relative to pet door assemblies of the invention.

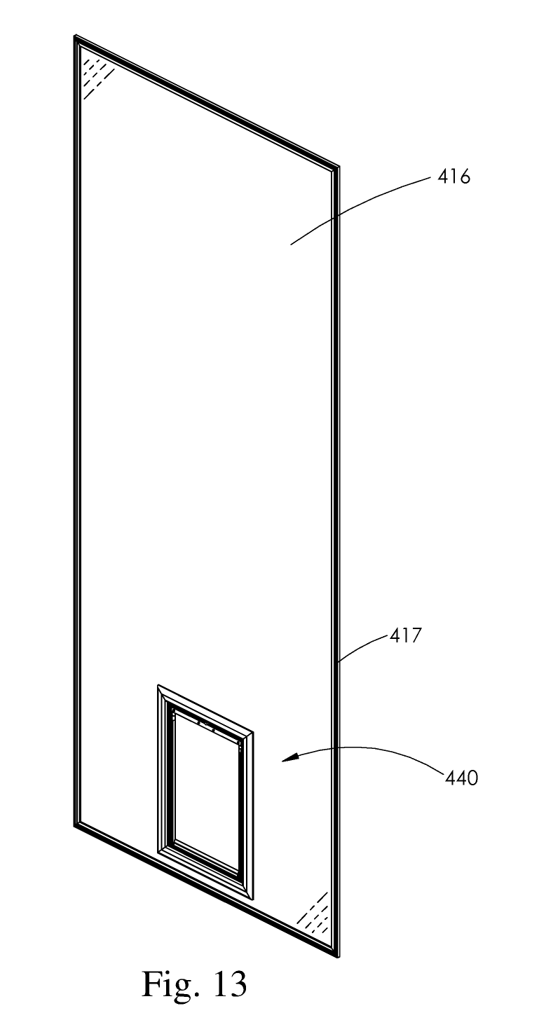

FIG. 13 is a perspective view of an embodiment of a glass panel 416 having a frame 417 and including a pet door assembly 440, in accordance with the invention. As with the panel 216 discussed above, glass panel 416 can be used to retrofit a door that was originally made without a pet door assembly, or to replace a broken pet door panel, for example.

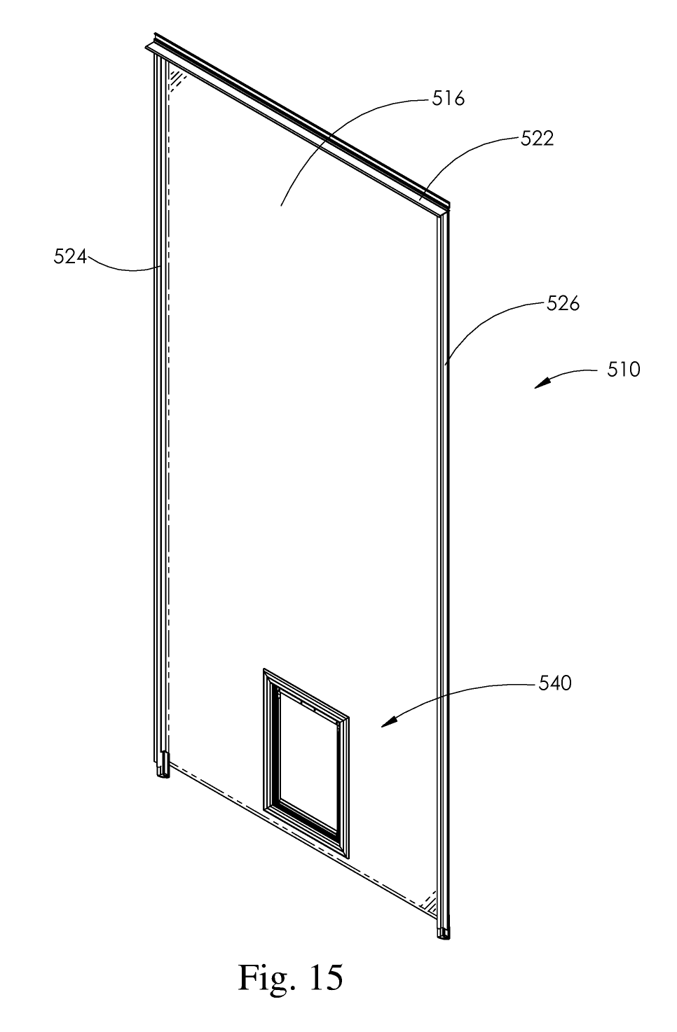

FIG. 15 is a perspective view of an embodiment of a door assembly 510 that includes a panel 516, which may be made of glass, for example, operably mounted to a structure that includes a top frame 522, left frame member 524, and right frame member 526. Panel 516 further includes a pet door assembly 540 mounted thereto, such as is described herein relative to other pet door assemblies.

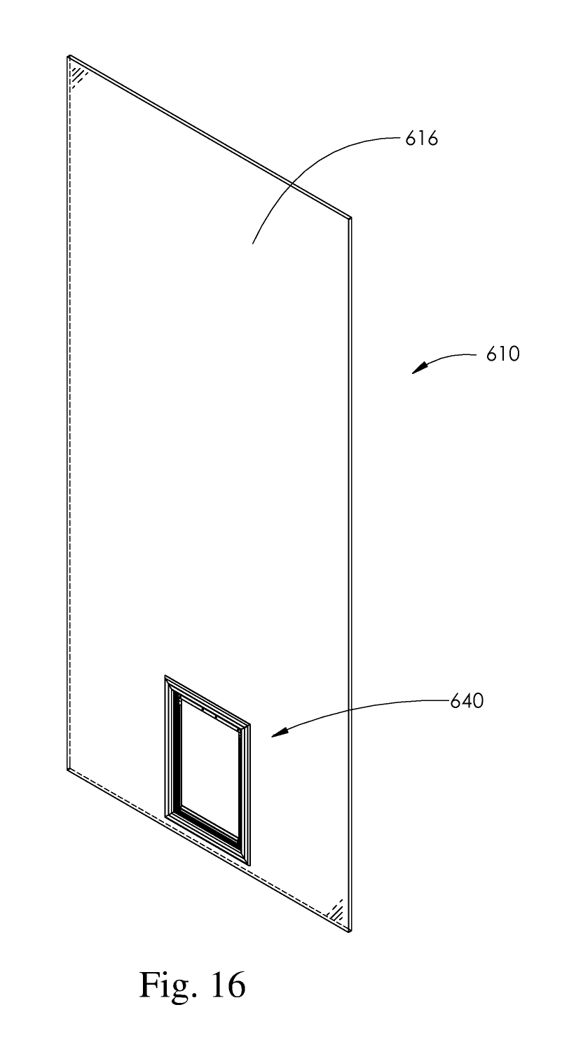

FIG. 16 is a perspective view of an embodiment of an assembly 610 that includes a panel 616, which may be made of a clear, translucent, or opaque glass or plastic sheet, for example. While the panel 616 is shown as rectangular, such as can be used for a door, for example, panel 616 may instead have a slightly or substantially different outer perimeter shape, such as square, circular, triangular, irregular, or the like. Panel 616 further includes a pet door assembly 640 mounted thereto, such as is described herein relative to other pet door assemblies.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A door assembly comprising:
a door structure;
at least a first panel mounted within the door structure, wherein the first panel includes a pet door opening; and
a pet door assembly mounted to the first panel, wherein the pet door assembly comprises:
an exterior frame positioned on a first side of the first panel adjacent the pet door opening;
an interior frame positioned on a second side of the first panel adjacent the pet door opening; and
a pet door flap mounted to one of the interior frame and exterior frame or between the interior frame and exterior frame and positioned within the pet door opening.

2. The door assembly of claim 1, further comprising a second panel mounted within the door structure, wherein the second panel is vertically repositionable relative to the first panel.

3. The door assembly of claim 1, wherein the exterior frame is attached to the interior frame through the pet door opening.

4. The door assembly of claim 1, wherein the pet door flap comprises a lower edge and a pet door magnet extending along at least a portion of the lower edge.

5. The door assembly of claim 4, wherein the pet door magnet comprises a U-shaped member.

6. The door assembly of claim 4, wherein a portion of at least one of the interior frame and the exterior frame comprises a frame magnet.

7. The door assembly of claim 1, wherein a portion of both the interior frame and exterior frame comprise a frame magnet.

8. The door assembly of claim 1, wherein at least one of the interior frame, the exterior frame, and the pet door flap comprises a magnetized surface, and wherein at least one surface that is not magnetized of the interior frame, the exterior frame, and the pet door flap comprises a ferromagnetic material.

9. The door assembly of claim 2, wherein the second panel is repositionable to expose a screen portion within the door structure.

10. The door assembly of claim 2, further comprising a stationary screen member adjacent to the second panel.

11. The door assembly of claim 1, wherein the pet door flap is vertically adjustable.

12. The door assembly of claim 1, further comprising a removable pet door cover adjacent the interior frame of the pet door assembly.

13. The door assembly of claim 1, wherein the exterior frame of the pet door assembly comprises at least one connector member for accepting a fastener.

14. The door assembly of claim 13, wherein the fastener comprises a threaded screw.

15. The door assembly of claim 13, wherein the at least one connector member is not accessible from an outer surface of the exterior frame.

16. The door assembly of claim 1, wherein at least one of the exterior frame and the interior frame are adhered to the first side and second side of the first panel, respectively.

17. The door assembly of claim 16, wherein at least one of the exterior frame and the interior frame are adhered to the first panel using at least one of a bead of structural adhesive and a structural adhesive tape.

18. A door assembly comprising:
a door structure;
a panel mounted within the door structure, wherein the panel includes a pet door opening; and
a pet door assembly mounted to the panel, wherein the pet door assembly comprises:
an exterior frame positioned on a first side of the panel;
an interior frame positioned on a second side of the panel; and
a pet door flap mounted to one of the interior frame and the exterior frame or between the interior frame and the exterior frame and positioned within the pet door opening;
wherein the exterior frame is attached to the interior frame through the pet door opening.

19. A panel assembly for use in a pet access application, the panel assembly comprising:
a panel comprising a first side and a second side, wherein the panel comprises one of a clear, translucent, or opaque glass or plastic sheet;
a pet door opening extending from the first side to the second side;
a pet door assembly mounted to the panel, the pet door assembly comprising:
an exterior frame positioned adjacent the first side;
an interior frame positioned adjacent the second side; and
a pet door flap mounted to one of the interior frame and the exterior frame or between the interior frame and the exterior frame and positioned within the pet door opening.

20. The panel assembly of claim 19, wherein the exterior frame is attached to the interior frame through the pet door opening.
